(19) United States
(12) Patent Application Publication
(10) Pub. No.: US 2026/0057680 A1
(43) Pub. Date: Feb. 26, 2026

(54) MOBILE BODY ASSISTANCE DEVICE AND MOBILE BODY SYSTEM

(71) Applicant: HONDA MOTOR CO., LTD., Tokyo (JP)

(72) Inventors: Naoki Hosomi, Saitama (JP); Masanori Yoshihira, Saitama (JP); Anirudh Reddy Kondapally, Saitama (JP)

(73) Assignee: HONDA MOTOR CO., LTD., Tokyo (JP)

(21) Appl. No.: 19/106,058

(22) PCT Filed: Sep. 15, 2022
(86) PCT No.: PCT/JP2022/034631

§ 371 Date: Feb. 24, 2025

(51) Int. Cl. G06V 20/58; G06V 10/82

(52) U.S. Cl. CPC G06V 20/58; G06V 10/82

(57) ABSTRACT

In view of an intension of an instructor whose space designation based on a target place is an ambiguous instruction, provided is a mobile body that can search for an appropriate area around the target place for the mobile body to realize a designated state according to the instruction. The model is constructed using the scene graphs SG1 to SG3 created based on the user's instruction and the environmental image corresponding to the position of the mobile body 20 and the direction facing the designated place as input data. The feature amount of the primary node constituting the state scene graph SG1 is defined according to relative arrangement relationship (distance and angle) with each object with respect to the position of the mobile body 20. The feature amount of the primary node constituting the state scene graph SG1 is defined according to the space occupancy mode of each object.

### TECHNICAL FIELD

The present invention relates to a mobile body assistance device and a mobile body system including the mobile body assistance device and a mobile body having a movement function.

### BACKGROUND ART

A method for generating a scene graph from an image has been proposed (see, for example, Non Patent Literatures 1 and 2). According to this method, a step of inputting an image, a step of detecting an object from the image using an object detection method based on deep learning, a step of detecting a context situation in the image using PLSI, a step of detecting a relationship between objects using a relationship detection and ontology method based on deep learning, and a step of generating a scene graph for the input image are executed.

### CITATION LIST

### Non Patent Literature

Non Patent Literature 1: Learning 3D Semantic Scene Graphs from 3D Indoor Reconstructions, CVPR2020 (https://arxiv.org/pdf/2004.03967v1.pdf) Non Patent Literature 2: Multi-Layer Semantic and Geometric Modeling with Neural Message Passing in 3D Scene Graphs for Hierarchical Mechanical Search, ICRA2020 (https://arxiv.org/pdf/2012.04060.pdf)

### SUMMARY OF INVENTION

### Technical Problem

However, according to the conventional technique, even when a user instructs a mobile body such as a robot to “Stop to the right of ∘∘ (for example, a name of a store, facility, or the like)”, it is difficult to stop the mobile body in an area corresponding to “the right of ∘∘” intended by the user. This is because, although coordinates of a point are required to stop the mobile body, the point is not uniquely expressed by the expression “right” included in the user's instruction. In the first place, the user does not perceive the expression “right” as the coordinates of a uniquely determined point, and often indicates the expression as the “space” of the right. Therefore, it is necessary to associate the word included in the user's instruction with the space. Furthermore, in the space “right”, there are a space in which the mobile body can stop and a space in which the mobile body cannot stop. For example, if “the right of ∘∘” is a vacant space, the mobile body can stop, and if it is a crosswalk, the mobile body cannot stop.

Therefore, an object of the present invention is to provide a mobile body system in which a mobile body can search for an appropriate area around a target place in order for the mobile body to realize a designated state according to an instruction, in view of an intention of an instructor whose space designation based on the target place is latent in an ambiguous instruction.

### Solution to Problem

A mobile body assistance device according to the present invention
outputs one area candidate among a plurality of area candidates existing in a plurality of surrounding spaces based on a designated place by inputting:
an instruction to a mobile body regarding realization of a designated state in a designated space around the designated place;
position information of the mobile body; and
a plurality of scene graphs created based on an image of a vicinity of the designated place acquired based on a positional relationship between the mobile body and the designated place, to a trained model.

### BRIEF DESCRIPTION OF DRAWINGS

FIG. 1 is an explanatory diagram regarding configurations of a learning device and a mobile body assistance device.

FIG. 2 is an explanatory diagram related to a function of generating a trained model.

FIG. 3 is an explanatory diagram related to an image including a plurality of objects.

FIG. 4 is an explanatory view of a result of projecting a three-dimensional high definition map onto a two-dimensional map.

FIG. 5 is an illustrative diagram of a state scene graph.

FIG. 6 is an illustrative diagram of a layout scene graph.

FIG. 7 is an illustrative diagram of an instruction scene graph.

FIG. 8 is a conceptual explanatory diagram of sequential convolution and pooling of a scene graph.

FIG. 9 is an explanatory diagram related to a graph neural network.

FIG. 10 is a conceptual explanatory diagram of sequential convolution and pooling of a scene graph input to a graph neural network.

FIG. 11 is an explanatory view related to ground truth data in different traveling scenes.

FIG. 12 is an explanatory view related to ground truth data in traveling scenes in which existence modes of obstacles are different.

FIG. 13 is an explanatory diagram related to an area candidate output function of the mobile body assistance device.

### DESCRIPTION OF EMBODIMENTS

### Configuration

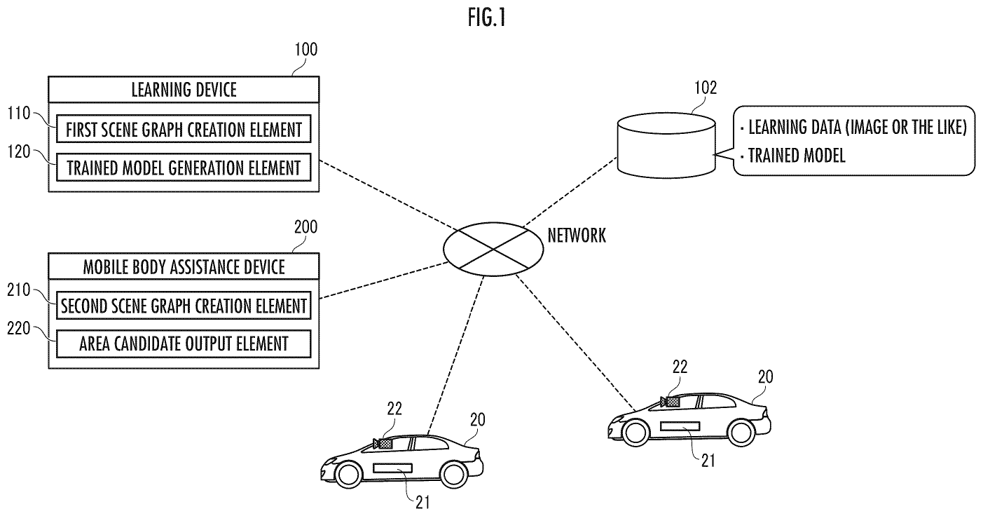

Each of a learning device 100 and a mobile body assistance device 200 as an embodiment of the present invention illustrated in FIG. 1 is configured as a device that can access a database 102 via a network in order to support the realization of the designated state of a mobile body 20. The mobile body 20 and mobile body assistance device 200 constitute a “mobile body system”.

The database 102 stores and holds an environmental image (corresponds to an “image” of the present invention) representing a state around the mobile body 20, a three-dimensional high definition map (map information), a graph neural network graph, a trained model, and the like. In the present embodiment, the database 102 is configured by a device or a database server separate from the learning device 100 and the mobile body assistance device 200, but may be a component of the learning device 100 and/or the mobile body assistance device 200.

The learning device 100 includes a first scene graph creation element 110 and a trained model generation element 120. Each of the first scene graph creation element 110 and the trained model generation element 120 includes an arithmetic processing element such as a CPU and/or a processor core, a storage element such as a ROM and/or a RAM, an input/output interface circuit, and the like. Each of the first scene graph creation element 110 and the trained model generation element 120 is configured to perform a designated task, such as each of scene graph creation and trained model generation described below. The functional element being configured to execute the designated task means that hardware constituting the functional element reads software and data as necessary from the storage element, and executes arithmetic processing on the data or other data according to the software to execute the designated task.

The mobile body assistance device 200 includes a second scene graph creation element 210 and an area candidate output element 220. Each of the second scene graph creation element 210 and the area candidate output element 220 includes an arithmetic processing element such as a CPU and/or a processor core, a storage element such as a ROM and/or a RAM, an input/output interface circuit, and the like. Each of the second scene graph creation element 210 and the area candidate output element 220 is configured to perform a designated task, such as each of scene graph creation and trained model generation described below.

The learning device 100 and the mobile body assistance device 200 may be configured by the same device. In this case, the first scene graph creation element 110 and the second scene graph creation element 210 may be constituted by a single scene graph creation element.

The mobile body 20 includes a vehicle or a robot having an autonomous movement function, a positioning function, and a wireless communication function. The mobile body 20 includes a mobile body control device 21 and an imaging device 22. The mobile body 20 may be constituted by an information processing terminal (for example, a smartphone) that is carried by a user and passively moves with the movement of the user. The mobile body assistance device 200 may be constituted by a device (for example, the mobile body control device 21) mounted on mobile body 20.

The mobile body control device 21 includes an arithmetic processing element such as a CPU and/or a processor core, a storage element such as a ROM and/or a RAM, an input/output interface circuit, and the like. The mobile body control device 21 is configured to control the autonomous movement function, the positioning function, and the wireless communication function of the mobile body 20. The imaging device 22 is mounted on the mobile body 20 so as to capture an image of a state in a traveling direction or in front of the mobile body 20. The mobile body 20 may have a function of adjusting an imaging direction (optical axis direction) of the imaging device 22 and/or a function of measuring the imaging direction.

### (Trained Model Generation Function)

With the trained model generation function, the trained model is generated on the basis of an instruction regarding the designated state of the mobile body 20 in the designated space around the designated place and an environmental image representing the designated place and the surrounding state acquired according to the position of the mobile body 20 and the direction facing the designated place.

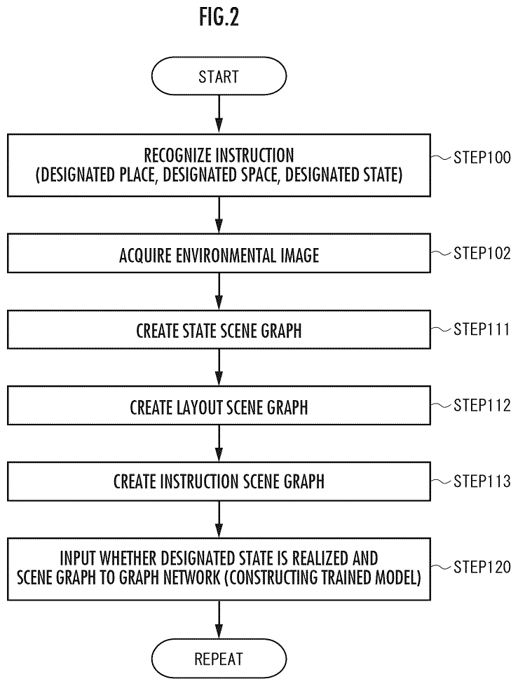

Specifically, an instruction by the user to the mobile body 20 through the input interface of the device owned by the user is transmitted from the device to the learning device 100, and is recognized by the first scene graph creation element 110 (FIG. 2/STEP100). The environmental image may be stored and held in the database 102, or may be directly transmitted from the device to the learning device 100.

The “instruction” is an instruction regarding a designated state of the mobile body 20 in the designated space around the designated place. As a result, for example, an instruction “Please stop to the right of X” is recognized as an instruction regarding realization of a stopped state as the designated state of the mobile body 20 in the space to the right as the designated space around the designated place represented by the word X. Furthermore, the instruction “Please decelerate before Y” is recognized as an instruction regarding realization of a state of starting deceleration as the designated state of the mobile body 20 in the space on the front side as the designated space around the designated place represented by the word Y Furthermore, an instruction “Please pass to the left of Z” is recognized as an instruction regarding realization of a passing state as the designated state of the mobile body 20 in the space on the left side as the designated space around the designated place represented by the word Z.

The user who issues the instruction may be a user in a place different from the mobile body 20 in addition to the user on the mobile body 20. The user's instruction may be a voice instruction or a gesture instruction.

The imaging device 22 mounted on the mobile body 20 acquires the environmental image representing the designated place and the surrounding state acquired according to the position of the mobile body 20 and the direction (the imaging direction of the imaging device 22) facing the designated place (FIG. 2/STEP102). The environmental image may be stored and held in the database 102, or may be directly transmitted from the mobile body 20 to the learning device 100.

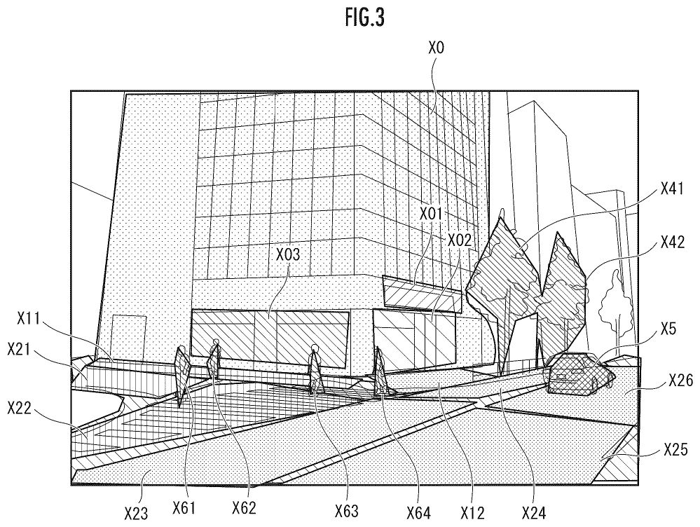

As a result, for example, as illustrated in FIG. 3, an environmental image including a building X₀ (building), sidewalk grids X₁₁ and X₁₂ extending along lower edges of two side surfaces of the building X₀, roadway grids X₂₁ to X₂₆ extending outside the sidewalk grids X₁₁ and X₁₂ as viewed from the building X₀, and trees X₄₁ and X₄₂ standing on boundaries between the sidewalk grid X₁₂ and the roadway grid X₂₄ is acquired. One side of the building X₀ has a store sign X₀₁ and a window X₀₂, and the other side has a window X₀₃. The environmental image illustrated in FIG. 3 further includes a vehicle X₅ and pedestrians X₆₁ to X₆₄ as traffic participants.

A state scene graph SG1 is created by the first scene graph creation element 110 based on the position of the mobile body 20 (at the time when the environmental image is acquired), the environmental image, and the map information (FIG. 2/STEP111).

The map information is, for example, a three-dimensional high definition map, and includes static information such as a three-dimensional structure, road surface information, and lane information, where types and/or attributes of objects or things are defined to be distinguished by labels. For example, each of an object having a certain height or more from the ground and an object spreading along the terrain is distinguished by a label. The label is defined by a label area (an area occupied by the labeled object in the environmental image) and a label ID.

The “objects having a certain height or more from the ground” as a first object are classified into, for example, a second object such as a building, a columnar structure, and a tree. “Buildings” which are the second object are classified into, for example, a third object such as a side wall, a store sign, a window, and an entrance for a person or a vehicle. The “columnar structure” which is the second object is classified into, for example, a third object such as a traffic signal pole, a traffic sign pole, and a communication pole. After the third object, the objects may be further finely classified.

The “object spreading along the terrain”, which is the first object, is classified into, for example, a second object such as a roadway and a sidewalk. The “roadway” as the second object is divided into a plurality of roadway grids as the third object, and each roadway grid is defined as an individual object. The “roadway grid”, which is the third object, is classified into a fourth object such as a road sign such as a crosswalk, a center line, a lane boundary line, and a zebra zone. The “sidewalk” which is the second object is divided into, for example, a plurality of sidewalk grids, and each sidewalk grid is defined as an individual object. The “sidewalk grid” which is the third object is classified into the fourth object such as a road mark such as a braille block. After the fourth object, the objects may be further finely classified.

A label defined in the three-dimensional high definition map is assigned to each of the objects shown in the environmental image. A label is also assigned to an object corresponding to dynamic information, such as a vehicle present on a roadway, a pedestrian present on a sidewalk or a roadway (pedestrian crosswalk). In the state scene graph SG1, each object (or its label) to which a label is assigned is defined as a primary node.

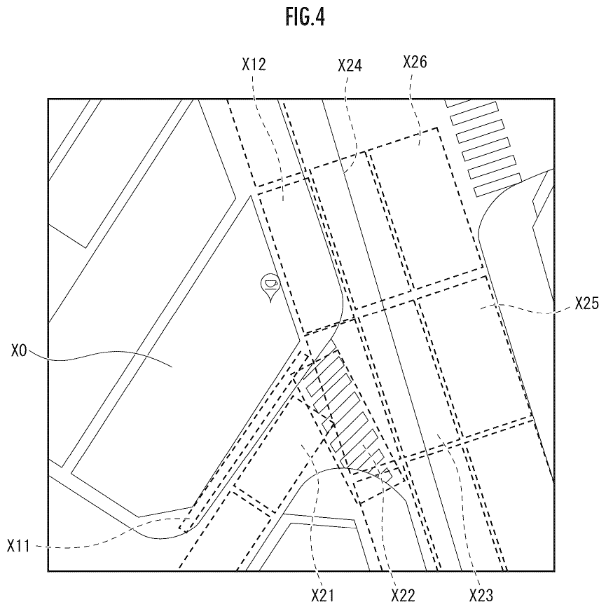

FIG. 4 illustrates a result of projecting a static object (building, sidewalk grid, and road grid) of a three-dimensional high definition map as a two-dimensional map. The two-dimensional map illustrated in FIG. 4 includes a building X₀ (building) as a static object, sidewalk grids X₁₁ and X₁₂ extending along two side lower edges of the building X₀, and roadway grids X₂₁ to X₂₆ among the objects included in the environmental image illustrated in FIG. 3. By using the two-dimensional map, a recognition accuracy of an adjacency relationship of each object and the relative arrangement relationship with each object with respect to the mobile body 20 is improved.

In the state scene graph SG1, an adjacency relationship of each object is defined as an edge. The adjacency relationship of objects indicates in which direction (for example, in the front-rear and left-right directions) another object adjacent to one object exists with reference to the one object.

The feature amount of the primary node is defined according to the relative arrangement relationship between the object and the mobile body 20 and the space occupancy mode of the object. The relative arrangement relationship between the object and the mobile body 20 is defined by a center or a center of gravity of the object (or label), a relative distance between the mobile body 20 (or the imaging device 22) and the object, and an azimuth angle in a direction in which the object exists based on an azimuth according to a traveling direction or a posture of the mobile body 20.

In a case where an environmental image (for example, a distance measurement image having a distance from the imaging device 22 as a pixel value) including information that can specify the primary node and its feature amount is obtained, the three-dimensional high-definition map may not be used.

The space occupancy mode of the object is defined by, for example, an occupancy flag (0. Unoccupied, 1. Occupied) indicating whether or not a static object (building, columnar structure, tree, and the like) occupies an area in a form that does not allow passage of the mobile body 20 (whether or not the static object corresponds to an object having a certain height or more from the ground). Furthermore, the space occupancy mode of the object is defined by an interference flag (0. Absence, 1. Presence) indicating whether or not a dynamic object (vehicle, pedestrian, or the like) as a designated object exists in the area in a form capable of interfering with the mobile body 20.

For example, when an object corresponding to the primary node is a “road grid” and there is another vehicle or the like in the road grid, the mobile body 20 can pass through an area corresponding to the object but may interfere with the other vehicle or the like. Therefore, the occupancy flag is defined as “0”, but the interference flag is defined as “1”. However, regarding the roadway grid in which it is not allowed to stop in view of the road mark (for example, crosswalk or parking/stopping prohibited), “1” is defined or assigned as the occupancy flag when the designated state of the mobile body 20 corresponds to a stop state. The feature amount of the primary node may be further defined by a “label area” and a “label ID.”

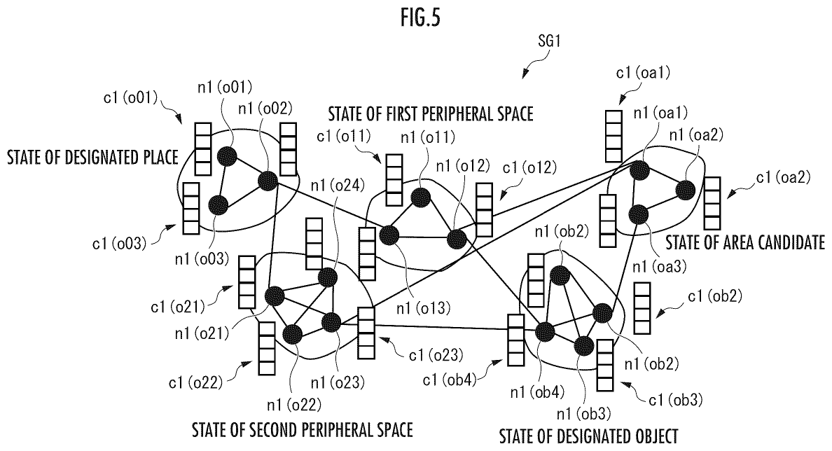

As schematically illustrated in FIG. 5, in the state scene graph SG1, a plurality of primary nodes n₁₍ₓ₎ (x represents each object or its label) having a feature amount c1(x) is associated with edges. The scene graph SG1 illustrated in FIG. 5 includes objects o₀₁, o₀₂, and o₀₃ representing the state of the designated place (for example, the designated store or the building containing the designated store), objects o₁₁, o₁₂, and o₁₃ representing the state of a first surrounding space (for example, the space on the south side of the building) with reference to the designated place, objects o₂₁, o₂₂, o₂₃, and o₂₄ representing the state of the second surrounding space (for example, the space on the east side of the building) with reference to the designated place, objects oₐ₁, oₐ₂, and oₐ₃ representing the state of the area candidate (for example, the road grid), and objects o_{b1}, o_{b2}, o_{b3}, and o_{b4} representing the state of the designated object (for example, the traffic participant).

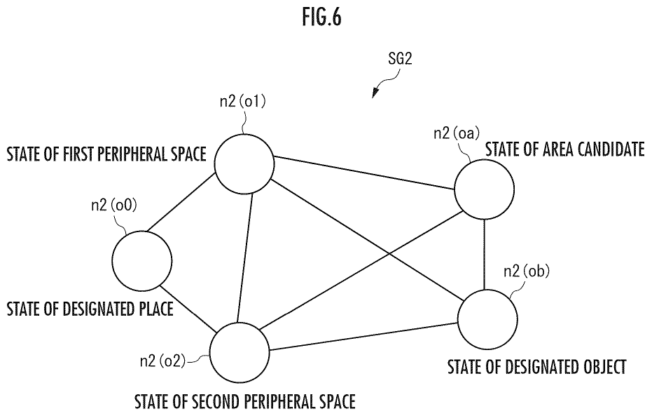

Subsequently, the state scene graph SG1 is convolved and pooling is performed by the first scene graph creation element 110 to create a layout scene graph SG2 (FIG. 2/STEP112). As a result, for example, the layout scene graph SG2 schematically illustrated in FIG. 6 is created as a result of convoluting the state scene graph SG1 schematically illustrated in FIG. 5. The granularity of the layout scene graph SG2 is lower than the granularity of the state scene graph SG1 before convolution.

Each of secondary nodes n₂₍ₒ₀₎, n₂₍ₒ₁₎, n₂₍ₒ₂₎, n₂₍ₒₐ₎, and n_{2(ob)} defining the layout scene graph SG2 illustrated in FIG. 6 represents each of primary node clusters respectively corresponding to “designated place”, “first surrounding space” and “second surrounding space”, “area candidates in a plurality of surrounding spaces”, and “designated object”. For example, the primary node cluster corresponding to the designated place includes primary nodes n₁₍ₒ₀₁₎, n₁₍ₒ₀₂₎, and n₁₍ₒ₀₃₎ representing the state of the designated place (for example, the designated store or the building containing the designated store) in the state scene graph SG1 illustrated in FIG. 5. An edge defining the layout scene graph SG2 illustrated in FIG. 6 represents an adjacency relationship of object clusters corresponding to primary node clusters represented by the secondary nodes n₂₍ₒ₀₎, n₂₍ₒ₁₎, n₂₍ₒ₂₎, n₂₍ₒₐ₎, and n_{2(ob)}. For example, an edge between the secondary node n₂₍ₒ₀₎ corresponding to the “designated place” and n₂₍ₒ₂₎ corresponding to the “second surrounding space” indicates that the second surrounding space is on the east side of the designated place. Each of the secondary nodes n₂₍ₒ₀₎, n₂₍ₒ₁₎, n₂₍ₒ₂₎, n₂₍ₒₐ₎, and n_{2(ob)} has a feature amount (as a result of aggregating the feature amounts of the primary node cluster) determined according to the feature amount of the primary node cluster to be convolved.

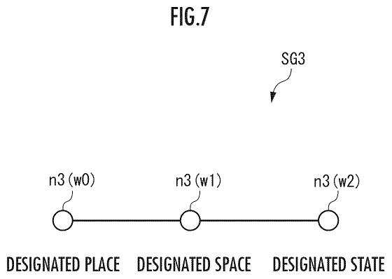

Further, the layout scene graph SG2 is convolved and pooling is performed by the first scene graph creation element 110 to create the instruction scene graph SG3 (FIG. 2/STEP113). As a result, for example, the instruction scene graph SG3 schematically illustrated in FIG. 7 is created as a result of convoluting the layout scene graph SG2 schematically illustrated in FIG. 6. The granularity of the instruction scene graph SG3 is lower than the granularity of the layout scene graph SG2 before convolution.

Each of the tertiary nodes n_{3(w0)}, n_{3(w1)}, and n_{3(w2)} defining the instruction scene graph SG3 illustrated in FIG. 7 represents a secondary node cluster corresponding to a word related to each of “designated place”, “designated space”, and “designated state” included in the user's instruction. For example, the secondary node cluster corresponding to the designated space includes secondary nodes n₂₍ₒ₁₎ and n₂₍ₒ₂₎ representing states of the first surrounding space and the second surrounding space in the layout scene graph SG2 illustrated in FIG. 6 and secondary nodes associated with these nodes through edges. An edge defining the instruction scene graph SG3 illustrated in FIG. 7 represents a word adjacency relationship. Each of the tertiary nodes n_{3(w0)}, n_{3(w1)}, and n_{3(w2)} has a feature amount determined according to the feature amount of the secondary node cluster to be convolved.

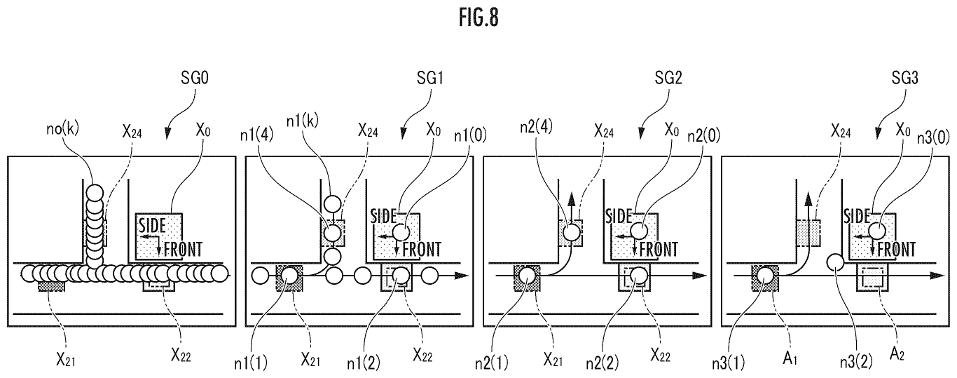

FIG. 8 conceptually illustrates a procedure in which the state scene graph SG1 (primary scene graph) is generated by convoluting and pooling an initial scene graph SG0, the layout scene graph SG2 (secondary scene graph) is generated by convoluting and pooling the state scene graph SG1, and the instruction scene graph SG3 (tertiary scene graph) is generated by convoluting and pooling the layout scene graph SG2. For example, general-purpose “Aggregate”, “Update”, or “Readout” is adopted as the convolution method, and “average pooling” is adopted as the pooling method.

Each of the scene graphs SG0, SG1, SG2, and SG3 illustrated in FIG. 8 includes a building X₀ as a destination or a designated place facing a three-way road (or a T-junction), and parking/stopping spaces X₂₁, X₂₂, and X₂₄ (as road grids) in the three-way road. As shown in FIG. 8, the parking/stopping space X₂₂ exists in front of the building X₀ (downward in the FIG. 8), the parking/stopping space X₂₄ exists beside the building X₀ (leftward in FIG. 8), and the parking/stopping space X₂₁ exists on a road not facing the building X₀. In this scene, an obstacle is present in the parking/stopping space X₂₁.

The initial scene graph SG0 illustrated in FIG. 8 includes a plurality of initial nodes n₀₍ₖ₎ arranged along a lane on which a vehicle approaching a three-way road from the left side can travel. The building X₀ as a goal is regarded as a node. Position information obtained by discretizing route information described on a three-dimensional map (high-resolution map) at unequal intervals is defined as a node. A grid having a predetermined size defined around a node has attributes of occupied/unoccupied/parking prohibited. The attributes of the grid are treated as parking prohibited in places such as crosswalks and intersections and/or road parking prohibited.

The state scene graph SG1 illustrated in FIG. 8 includes, in addition to the primary node n₀₍ᵢ₎ corresponding to the building X₀, a plurality of primary nodes n₁₍ₖ₎ arranged more sparsely than the plurality of initial nodes n₀₍ₖ₎ as a result of convolution and pooling of a plurality of initial nodes n₀₍ₖ₎ corresponding to the road grid. The plurality of primary nodes n₁₍ₖ₎ include primary nodes n₁₍₁₎, n₁₍₂₎, and n₁₍₄₎ respectively corresponding to parking/stopping spaces X₂₁, X₂₂, and X₂₄ on the three-way road.

The layout scene graph SG2 illustrated in FIG. 8 includes, in addition to the secondary node n₀₍₂₎ corresponding to the building X₀, the secondary nodes n₂₍₁₎, n₂₍₂₎, and n₂₍₄₎ respectively corresponding to the parking/stopping spaces X₂₁, X₂₂, and X₂₄ on the three-way road as a result of convolution and pooling of a plurality of primary nodes n₁₍ₖ₎ corresponding to the road grid. That is, each of the secondary nodes n₂₍₁₎, n₂₍₂₎, and n₂₍₄₎ is a result of convolution and pooling of a plurality of primary nodes n₁₍ₖ₎ existing in and near each of the parking/stopping spaces X₂₁, X₂₂, and X₂₄ on each of the three roads constituting the three-way road.

The instruction scene graph SG3 illustrated in FIG. 8 includes, in addition to the tertiary node n₃₍₀₎ corresponding to the building X₀, the tertiary node n₃₍₁₎ that is the same as the secondary node n₂₍₁₎ corresponding to the parking/stopping space X₂₁ in which an obstacle exists among the parking/stopping spaces X₂₁, X₂₂, and X₂₄, and the tertiary node n₃₍₂₎ as a result of convolution and pooling of the secondary nodes n₂₍₂₎ and n₂₍₄₎ corresponding to the parking/stopping spaces X₂₂ and X₂₄ in which no obstacle exists.

Next, the trained model generation element 120 inputs the state scene graph SG1, the layout scene graph SG2, and the instruction scene graph SG3 together with the area where the designated state of the mobile body 20 is realized to a graph neural network GNN as input data, thereby generating or constructing a trained model (FIG. 2/STEP120).

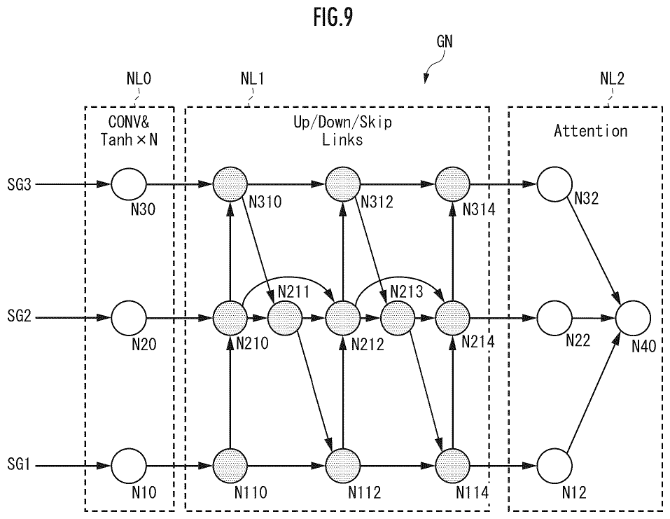

For example, as illustrated in FIG. 9, the graph neural network GNN includes an input layer NL0, an intermediate layer NL1, and an output layer NL2. A model is constructed by adjusting a value of a parameter such as a weight coefficient of each node constituting the graph neural network GNN so that one area candidate output from the graph neural network GNN matches a correct area indicated by input data (input data).

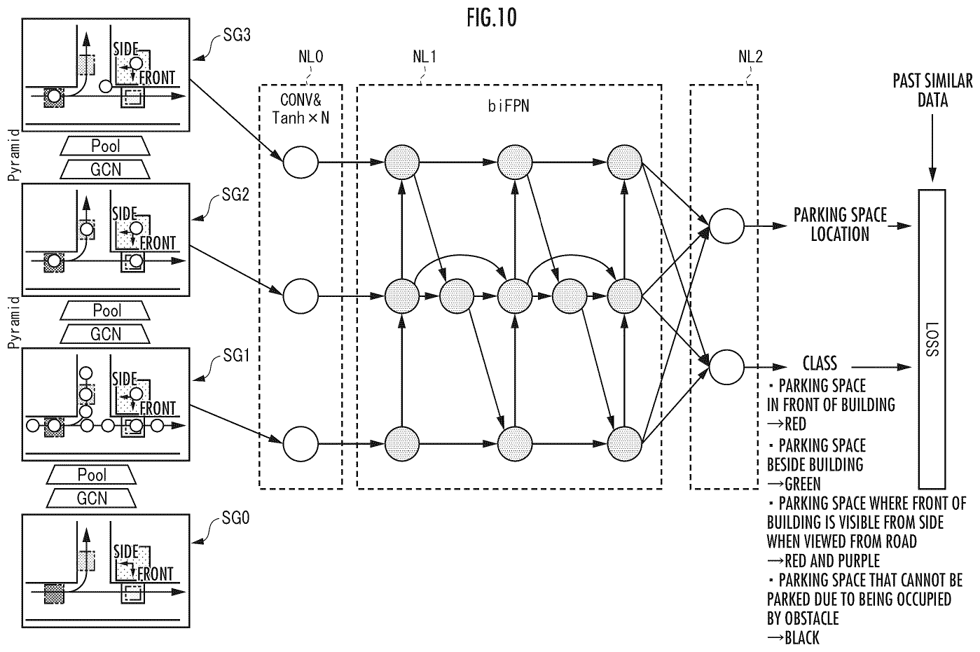

FIG. 10 conceptually illustrates a procedure in which the state scene graph SG1 (primary scene graph) is generated by convoluting and pooling the initial scene graph SG0, the layout scene graph SG2 (secondary scene graph) is generated by convoluting and pooling the state scene graph SG1, and the instruction scene graph SG3 (tertiary scene graph) is generated by convoluting and pooling the layout scene graph SG2. In FIG. 10, “GCN” represents convolution processing by the graph convolution neural network, and “Pool” represents pooling processing.

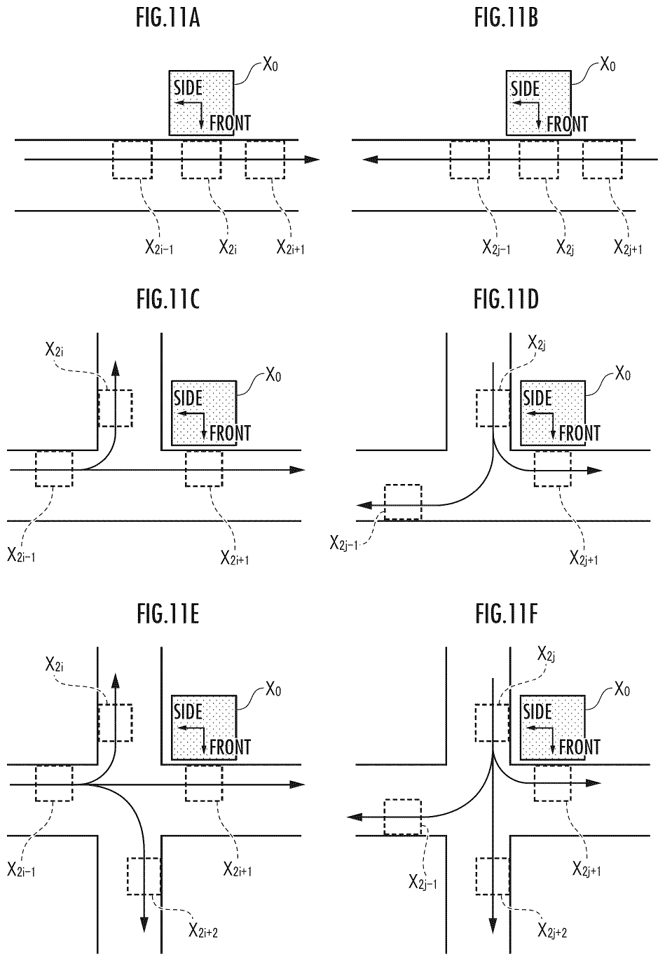

FIG. 11 illustrates ground truth data in each of different traveling scenes of the vehicle. As illustrated in FIG. 11(1), a traveling scene in which a vehicle approaches a building X₀ facing a road extending left and right from the left side of the drawing along the road will be described. In this traveling scene, for example, in response to instructions of “park in front of the building X₀”, “park beside the building X₀”, and “park near the building X₀”, it is defined as a correct answer to park and stop the vehicle in any one of the parking/stopping spaces X₂ᵢ₋1, X₂ᵢ, and X₂ᵢ₊₁ in front of the building X₀ (downward in the drawing) in the travelable lane of the road.

As illustrated in FIG. 11(2), a traveling scene in which a vehicle approaches a building X₀ facing a road extending left and right from the right side of the drawing along the road will be described. In this traveling scene, in response to a similar instruction, in a travelable lane of the road (a lane opposite to FIG. 11(1)), it is defined as a correct answer to park and stop the vehicle in any of the parking/stopping spaces X₂ⱼ₋1, X₂ⱼ, and X₂ⱼ₊ᵢ in front of the building X₀.

As illustrated in FIG. 11(3), a traveling scene in which a vehicle approaches a building X₀ facing a three-way road from the left side of the drawing will be described. In this traveling scene, for example, in response to instructions such as “park in front of the building X₀”, “park beside the building X₀”, and “park near the building X₀”, it is defined as a correct answer that the vehicle is parked or stopped in each of the parking/stopping space X₂ᵢ₊₁ in front of the building X₀ (downward in the drawing), the parking/stopping space X₂ᵢ beside the building X₀ (leftward in the drawing), and the parking/stopping space X₂ᵢ₋ᵢ slightly away from the building X₀ in the travelable lane of the three-way road.

As illustrated in FIG. 11(4), a traveling scene in which a vehicle approaches a building X₀ facing a three-way road from the upper side of the drawing will be described. In this traveling scene, for example, in response to instructions of “park in front of the building X₀”, “park beside the building X₀”, and “park near the building X₀”, it is defined as a correct answer that the vehicle is parked or stopped in each of the parking/stopping space X₂ⱼ beside the building X₀ (left direction in the figure), the parking/stopping space X₂ⱼ₊ᵢ in front of the building X₀ (downward direction in the figure), and the parking/stopping space X₂ⱼ₋ᵢ slightly away from the building X₀ in the travelable lane of the three-way road.

As illustrated in FIG. 11(5), a traveling scene in which a vehicle approaches a building X₀ facing a crossroad from the left side of the drawing will be described. In this traveling scene, for example, in response to instructions such as “park in front of the building X₀”, “park beside the building X₀”, and “park near the building X₀”, it is defined as a correct answer that the vehicle is parked or stopped in each of the parking/stopping space X₂ᵢ₊₁ in front of the building X₀ (downward in the figure), the parking/stopping space X₂ᵢ beside the building X₀ (leftward in the figure), and the parking/stopping space X₂ᵢ₋ᵢ or X₂ᵢ₊₂ slightly away from the building X₀ in the travelable lane of the crossroad.

As illustrated in FIG. 11(6), a traveling scene in which a vehicle approaches a building X₀ facing a crossroad from the upper side of the drawing will be described. In this traveling scene, for example, in response to instructions such as “park in front of the building X₀”, “park beside the building X₀”, and “park near the building X₀”, it is defined as a correct answer that the vehicle is parked or stopped in each of the parking/stopping space X₂ⱼ beside the building X₀ (left direction in the figure), the parking/stopping space X₂ⱼ₊ᵢ in front of the building X₀ (downward direction in the figure), and the parking/stopping space X₂ⱼ₋ᵢ or X₂ⱼ₊₂ slightly away from the building X₀ in the travelable lane of the crossroad.

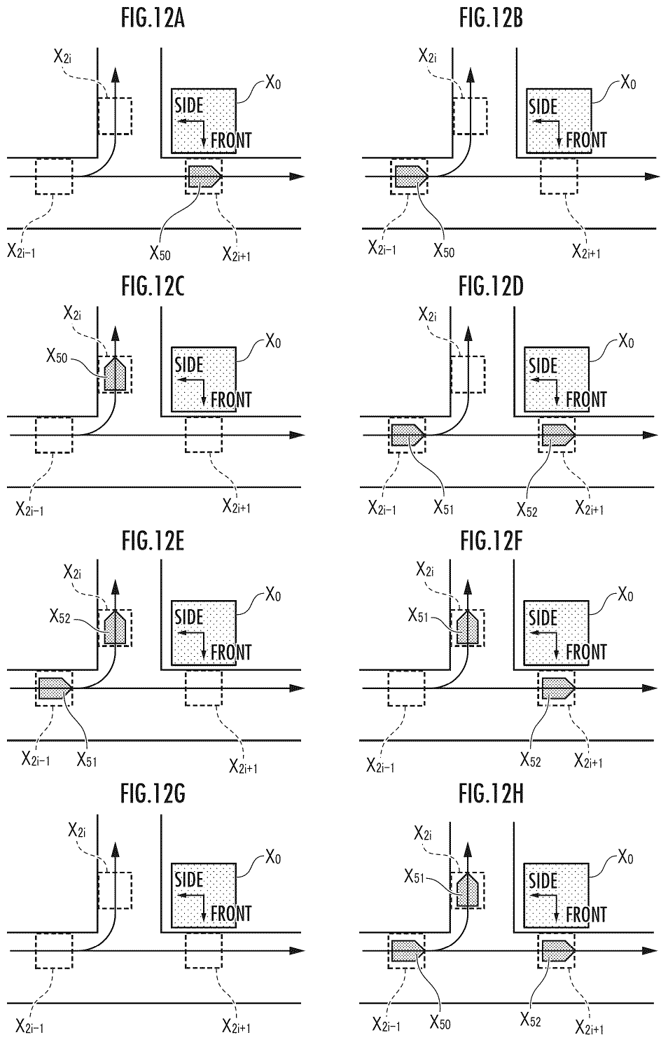

In FIG. 12, as illustrated in FIG. 11(3), ground truth data in a traveling scene in which the vehicle approaches the building X₀ facing the three-way road from the left side of the figure is illustrated. As illustrated in each of FIGS. 12(1) to 12(3), it is defined as a correct answer to park and stop the vehicle in any one of two parking/stopping spaces in which the obstacle X₅₀ does not exist among the parking/stopping spaces X₂ᵢ₋ᵢ, X₂ᵢ, and X₂ᵢ₊ᵢ. As illustrated in each of FIGS. 12(4) to 12(6), it is defined as a correct answer to park and stop the vehicle in one parking/stopping space in which each of the obstacles X₅₁ and X₅₂ does not exist among the parking/stopping spaces X₂ᵢ₋ᵢ, X₂ᵢ, and X₂ᵢ₊₁. As illustrated in FIG. 12(7), it is defined as a correct answer that the vehicle is parked or stopped in any one of the parking/stopping spaces X₂ᵢ₋ᵢ, X₂ᵢ, and X₂ᵢ₊₁ where no obstacle exists. As illustrated in FIG. 12(8), it is defined as a correct answer that the vehicle is not parked or stopped in any of the parking/stopping spaces X₂ᵢ₋ᵢ, X₂ᵢ, and X₂ᵢ₊₁ in which the obstacles X₅₀, X₅₁, and X₅₂ exist.

In each of the nodes N30, N20, and N10 constituting the input layer NL0, the feature amount of each of the primary, secondary, and tertiary nodes constituting each of the three scene graphs SG1 to SG3 is vectorized.

In the intermediate layer NL1, the weighting factor is propagated from bottom to top between nodes (node N110→N210→N310, node N112→N212→N312, node N114→N214→N314), and subsequently, the weighting factor is propagated from top to bottom between nodes (node N310→N211→N112, node N312→N213→N114). In the intermediate layer NL1, the weighting coefficients are propagated in the order of the nodes N210, N212, and N214 by skipping the intermediate nodes N211 and N213.

The output layer NL2 includes three nodes N32, N22, and N12 that output primary determination results corresponding to the three scene graphs SG1 to SG3, respectively, and a node N40 that outputs one area candidate as a secondary determination result by integrating the primary results. A graph attention network (GAN) may be employed as the graph neural network GNN. In this case, for example, by introducing attention, a score of importance (weighting factor) is assigned to the relationship among the three nodes N32, N22, and N12, and the output result is flexibly changed.

### (Area Candidate Output Function)

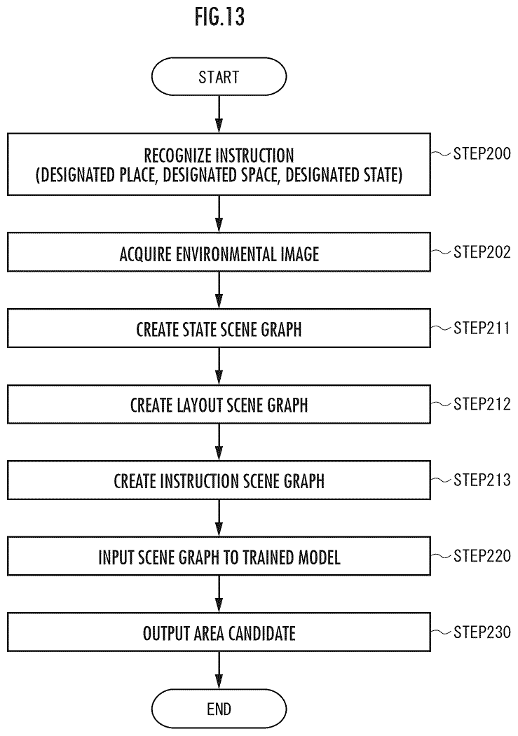

After the trained model is generated or constructed as described above, one area candidate is output according to an instruction from the user. Specifically, an instruction from the user to the mobile body 20 (the mobile body may be a mobile body different from the mobile body 20 used at the time of generating the trained model, or may be the same mobile body as the mobile body 20) through the input interface of the device owned by the user is transmitted from the device to the learning device 100, and is recognized by the first scene graph creation element 110 (FIG. 13/STEP200). The environmental image may be stored and held in the database 102, or may be directly transmitted from the device to the mobile body assistance device 200.

The imaging device 22 mounted on the mobile body 20 acquires the environmental image (see FIG. 3) representing the designated place and the surrounding state acquired according to the position of the mobile body 20 and the direction (the imaging direction of the imaging device 22) facing the designated place (FIG. 13/STEP202). The environmental image may be stored and held in the database 102, or may be directly transmitted from the mobile body 20 to the mobile body assistance device 200.

The state scene graph SG1 (see FIG. 5) is created by the second scene graph creation element 210 based on the position of the mobile body 20 (at the time when the environmental image is acquired), the environmental image, and the three-dimensional high definition map (FIG. 13/STEP211). Subsequently, the state scene graph SG1 is convolved by the second scene graph creation element 210 to create a layout scene graph SG2 (see FIG. 6) (FIG. 13/STEP212). Further, the layout scene graph SG2 is convolved by the second scene graph creation element 210 to create the instruction scene graph SG3 (see FIG. 7) (FIG. 13/STEP213).

Next, the state scene graph SG1, the layout scene graph SG2, and the instruction scene graph SG3 are input to the trained model generated on the basis of the graph neural network GNN (see FIG. 8) by the area candidate output element 220 (FIG. 13/STEP220). Then, one area candidate is output as the output of the trained model (FIG. 13/STEP230). On the basis of the output result of the trained model, the mobile body control device 21 controls the operation of the mobile body 20 so that the designated state of the mobile body 20 in one area candidate as the output result is realized. The output result of the trained model may be output to an output interface constituting the device.

### (Effects)

According to the learning device 100 that exerts the above-described function, the trained model is constructed using the scene graphs SG1 to SG3 created on the basis of the instruction of the user and the environmental image according to the position of the mobile body 20 and the direction facing the designated place as the input data (see FIG. 2).

The feature amount of the primary node constituting the state scene graph SG1 is defined according to a relative arrangement relationship (distance and angle) with each object with respect to the position of the mobile body 20. Therefore, the feature amount of the secondary node constituting the layout scene graph SG2 as a result of convolution of the state scene graph SG1 also reflects the relative arrangement relationship with each object based on the position of the mobile body 20. Furthermore, the feature amount of the tertiary node representing the word included in the instruction and constituting the instruction scene graph SG3 as a result of convolution of the layout scene graph SG2 also reflects the relative arrangement relationship with each object based on the position of the mobile body 20.

As a result, even if an arbitrary instruction of the user is vague space designation such as “right”, “front”, or “left”, the probability that an area (for example, a roadway grid) existing in the space intended by the user is output as one area candidate is improved (see FIG. 13).

In addition, the feature amount of the primary node constituting the state scene graph SG1 is defined according to the space occupancy mode of each object, specifically, an occupancy flag mainly representing the space occupancy state of the static object and an interference flag mainly representing the space occupancy state of the dynamic object. The same applies to the feature amount of the secondary node constituting the layout scene graph SG2 and the feature amount of the tertiary node constituting the instruction scene graph SG3.

As a result, one appropriate area candidate for the mobile body 20 to realize the designated state can be output from the trained model by the mobile body assistance device 200 while avoiding interference with the static object and the dynamic object.

For example, in response to the user's instruction of “Please stop to the right of X₀ (designated place)”, any one roadway grid X₂₁ or X₂₄ of the roadway grids X₂₁ to X₂₆ illustrated in FIG. 4 excluding the roadway grid X₂₂ corresponding to a crosswalk may be output from the trained model as one area candidate for realizing the stop state (designated state) of the mobile body 20. Furthermore, in response to the user's instruction “Please decelerate before X₀”, any one roadway grid X₂₁ or X₂₃ of the roadway grids X₂₁ to X₂₆ illustrated in FIG. 4 may be output from the trained model as one area candidate for realizing the deceleration start state (designated state) of the mobile body 20. Furthermore, in response to the user's instruction “Please pass to the left of X₀”, any one roadway grid X₂₂ of the roadway grids X₂₁ to X₂₆ illustrated in FIG. 4 may be output from the trained model as one area candidate for realizing the traveling state (designated state) of the mobile body 20.

### Other Embodiment of Present Invention

According to the above embodiment, the environmental image is acquired through the imaging device 22 mounted on the mobile body 20. However, a virtual image acquired through a virtual imaging device mounted on the mobile body 20 may be acquired as the environmental image using the three-dimensional high definition map or the two-dimensional map (map information) on the basis of the measurement result of the position and the traveling direction of the mobile body 20 in the global coordinate system or the map coordinate system.

### REFERENCE SIGNS LIST

Mobile body
22 Imaging device
100 Learning device
102 Database
110 First scene graph creation element
120 Trained model generation element
200 Mobile body assistance device
210 Second scene graph creation element
220 Area candidate output element

1. A mobile body assistance device, wherein
one area candidate is output among a plurality of area candidates existing in a plurality of surrounding spaces based on a designated place by inputting:
an instruction to a mobile body regarding realization of a designated state in a designated space around the designated place;
position information of the mobile body; and
a plurality of scene graphs created based on an image of a vicinity of the designated place acquired based on a positional relationship between the mobile body and the designated place, to a trained model.

2. The mobile body assistance device according to claim 1, wherein
the plurality of scene graphs include:
a state scene graph defined by a primary node representing each of a plurality of objects included in the image, created based on a position of the mobile body, the image and map information, an edge representing an adjacency relationship between the plurality of objects, and a feature amount of the primary node according to a relative arrangement relationship with the object based on the mobile body and a space occupancy state of the object; and
a layout scene graph created by convoluting the state scene graph, the layout scene graph being defined by a secondary node representing each of primary node clusters configured by one or a plurality of the primary nodes and corresponding to each of the designated places, a plurality of surrounding spaces based on the designated place, area candidates in the plurality of surrounding spaces, and designated objects, an edge representing an adjacency relationship between object clusters configured by one or a plurality of the objects corresponding to the primary node cluster, and a feature amount of the secondary node defined according to a feature amount of the primary node cluster.

3. The mobile body assistance device according to claim 2, wherein
an instruction scene graph is included in the plurality of scene graphs, the instruction scene graph being created by convoluting the layout scene graph and defined by a tertiary node configured by one or a plurality of the secondary nodes and representing secondary node clusters corresponding to each of words related to the designated place, the designated space, and the designated state included in the instruction, an edge representing an adjacency relationship of the words, and a feature amount of the tertiary node determined according to a feature amount of the secondary node cluster.

4. The mobile body assistance device according to claim 1, wherein
one area candidate is output among a plurality of area candidates existing in a plurality of surrounding spaces based on the designated place by inputting the plurality of scene graphs to the trained model generated using a graph neural network defined so that weights propagate from top to bottom between nodes constituting an intermediate layer and weights propagate from bottom to top between the nodes.

5. The mobile body assistance device according to claim 4, wherein
one area candidate is output among a plurality of area candidates existing in a plurality of surrounding spaces based on the designated place by inputting the plurality of scene graphs to the trained model generated using the graph neural network defined so that weights propagate from a node constituting one intermediate layer to a node constituting another intermediate layer existing with one or a plurality of intermediate layers interposed therebetween.

6. The mobile body assistance device according to claim 1, wherein
the image is an image captured by an imaging device mounted on the mobile body.

7. The mobile body assistance device according to claim 1, wherein
the designated state of the mobile body includes a stop state of the mobile body.

8. A mobile body system comprising: the mobile body assistance device according to claim 1 for supporting a mobile body; and the mobile body.
